(19) United States
(12) Patent Application Publication
(10) Pub. No.: US 2023/0186793 A1
(43) Pub. Date: Jun. 15, 2023

(54) Roll Display Sign Device

(71) Applicant: Jack Denton, Colorado Springs, CO (US)

(72) Inventor: Jack Denton, Colorado Springs, CO (US)

(21) Appl. No.: 17/547,355

(22) Filed: Dec. 10, 2021

(51) Int. Cl. G09F 7/18; B60R 11/00

(52) U.S. Cl. CPC G09F 7/18; B60R 11/00; B60R 2011/0056; B60R 2011/0026; G09F 2007/1865

(57) ABSTRACT

A roll display sign device for displaying an information sheet for a vehicle includes a housing, which defines an interior space. The housing is selectively engageable to a window of a vehicle so that the housing is removably engaged to the window. A slot is positioned in the housing. A panel, which is wound and which is positioned in the interior space, is reversibly extensible through the slot so that the panel is viewable through the window of the vehicle. The panel has indicia positioned thereon, can selectively engage indicia, or can selectively engage a sheet upon which indicia are positioned. The indicia are capable of being read by a person who is positioned proximate to the window.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sign devices and more particularly pertains to a new sign device for displaying an information sheet for a vehicle. The present invention discloses a sign device comprising a housing, which is selectively engageable to a window of a vehicle. A panel selectively extensible from the housing displays indicia, such as information about a vehicle that is for sale, which are readable by a person outside of the vehicle. The panel can be retracted to improve visibility while driving

### (2) Description of Related Art Including Information Disclosed Under 37 CFR 1.97 and 1.98

The prior art relates to sign device. Prior art sign devices may comprise roll display signs engageable to fuel pumps, rear view mirrors, store shelves, and the like. What is lacking in the prior art is a sign device comprising a housing, which is selectively engageable to a window of a vehicle. A panel selectively extensible from the housing displays indicia, such as information about a vehicle that is for sale, which are readable by a person outside of the vehicle.

### BRIEF SUMMARY OF THE INVENTION

An embodiment of the disclosure meets the needs presented above by generally comprising a housing, which defines an interior space. The housing is configured to selectively engage a window of a vehicle so that the housing is removably engaged to the window. A slot is positioned in the housing. A panel, which is wound and which is positioned in the interior space, is reversibly extensible through the slot so that the panel is viewable through the window of the vehicle. The panel has indicia positioned thereon, is configured to selectively engage indicia, or is configured to selectively engage a sheet upon which indicia are positioned. The indicia are capable of being read by a person who is positioned proximate to the window.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a roll display sign device according to an embodiment of the disclosure.

FIG. 2 is a front view of an embodiment of the disclosure.

FIG. 3 is a side view of an embodiment of the disclosure.

FIG. 4 is a rear view of an embodiment of the disclosure.

FIG. 5 is an in-use view of an embodiment of the disclosure.

### DETAILED DESCRIPTION OF THE INVENTION

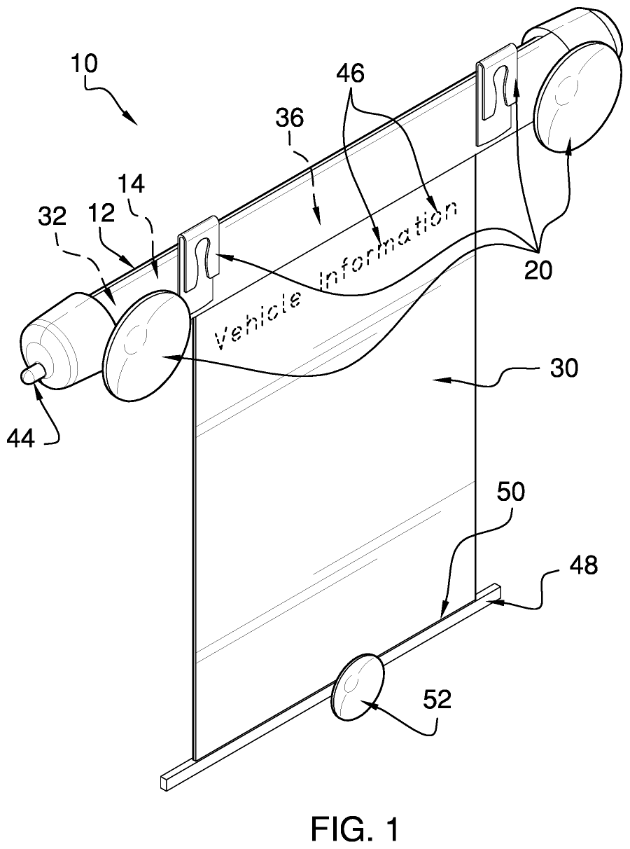

With reference now to the drawings, and in particular to FIGS. 1 through 5 thereof, a new sign device embodying the principles and concepts of an embodiment of the disclosure and generally designated by the reference numeral 10 will be described.

As best illustrated in FIGS. 1 through 5, the roll display sign device 10 generally comprises a housing 12, which defines an interior space 14. The housing 12 may be elongated cylindrically shaped, although the present invention also anticipates the housing 12 being cuboid shaped. The housing 12 is configured to selectively engage a window 16 of a vehicle 18 so that the housing 12 is removably engaged to the window 16.

A plurality of fasteners 20 is engaged to the housing 12 and is configured to selectively engage the window 16 of the vehicle 18 so that the housing 12 is removably engaged to the window 16. The plurality of fasteners 20 comprises one or both of a pair of cups 22 and a pair of hooks 24. The cups 22 are resiliently compressible and thus are configured to be compressed between the housing 12 and the window 16 to suctionally engage the housing 12 to the window 16. The cups 22 may comprise rubber, silicone, elastomer, or the like. The hooks 24 are configured for insertion of an upper edge 26 of the window 16 to engage the housing 12 to the window 16. Either the cups 22, the hooks 24, or both the cups 22 and the hooks 24 can be used to engage the housing 12 to the window 16.

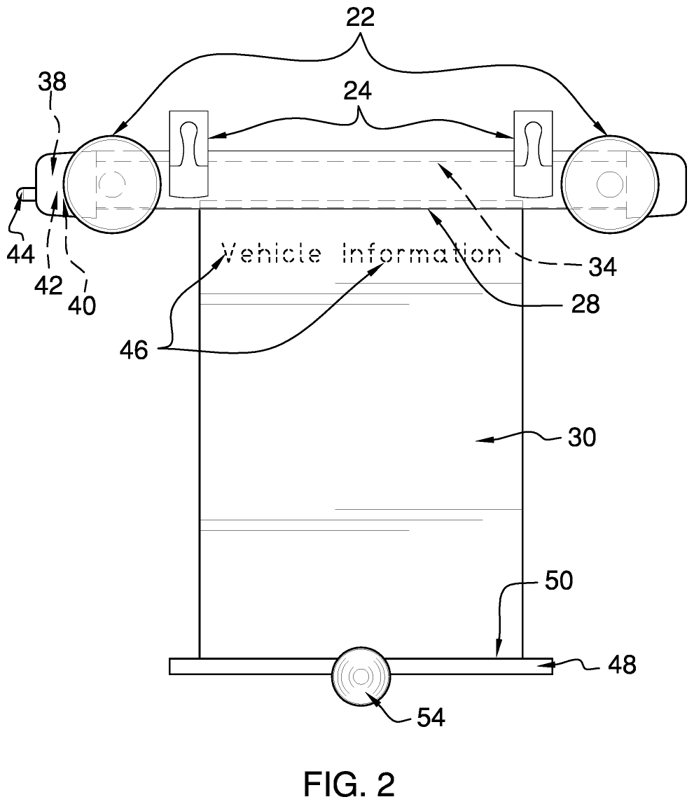

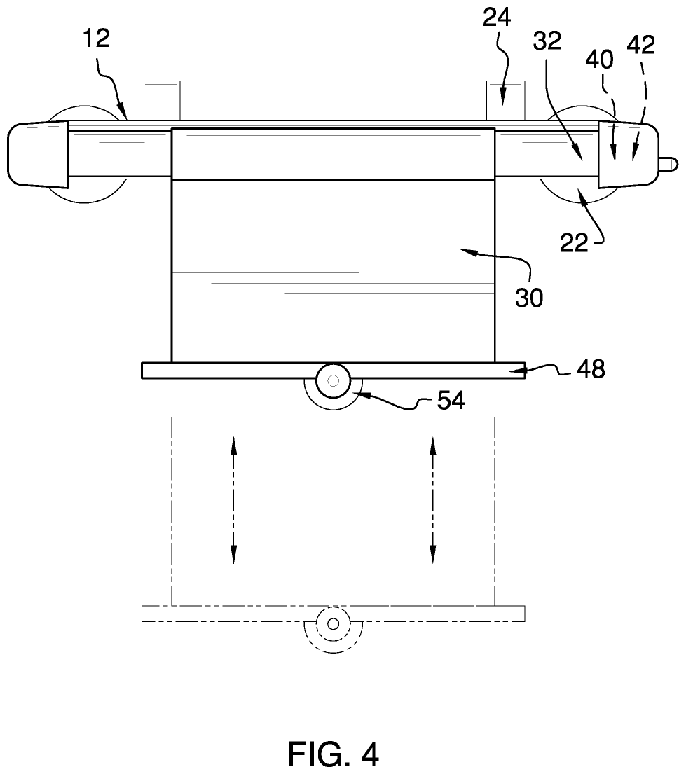

A slot 28 is positioned in the housing 12. A panel 30, which is wound and which is positioned in the interior space 14, is reversibly extensible through the slot 28 so that the panel 30 is viewable through the window 16 of the vehicle 18. An extension module 32 is engaged to the housing 12 and is operationally engaged to the panel 30. The extension module 32 enables selective positioning of the panel 30 in a retracted configuration, as shown in FIG. 4, and an extended configuration, as shown in FIG. 2. In the retracted configuration, the panel 30 is positioned within the housing 12. In the extended configuration, the panel 30 extends from the housing 12.

The extension module 32 comprises a tube 34, which is rotationally engaged to the housing 12 and which is positioned in the interior space 14. A first end 36 of the panel 30 is engaged to the tube 34. A spring 38 is engaged to the housing 12 and is operationally engaged to the tube 34 so that the spring 38 is tensioned as the panel 30 is extended from the housing 12. A ratchet 40 is engaged to the tube 34. A pawl 42 is hingedly engaged to the housing 12 and is gearedly engaged to the ratchet 40. A button 44 is engaged to the housing 12 and is operationally engaged to the pawl 42. The button 44 is configured to be depressed to disengage the pawl 42 from the ratchet 40 to retract the panel 30 into the housing 12.

The panel 30 may have indicia 46 positioned directly thereon. The panel 30 also may be configured to selectively engage indicia 46, such as by writing upon the panel 30 with erasable ink. The panel 30 also may be configured to selectively engage a sheet (not shown) upon which indicia 46 are positioned. For example, the panel 30 may comprise a sleeve (not shown) into which a sheet of paper is insertable.

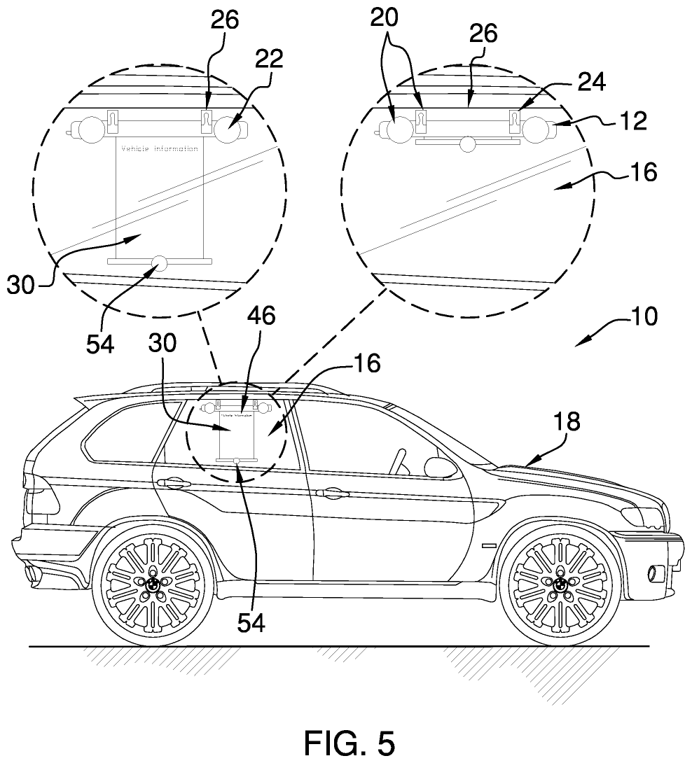

The indicia 46 are capable of being read by a person who is positioned proximate to the window 16, as shown in FIG. 5. The present invention is anticipated to be useful in displaying a window sticker for a new or used vehicle 18 that is for sale. Rather than the window sticker being affixed to the window 16, where it is both unsightly and a distraction during test drives, the required information can be displayed on the panel 30. As the panel 30 can be retracted into the housing 12, there is little obstruction to a driver's view through the window 16 while driving the vehicle 18.

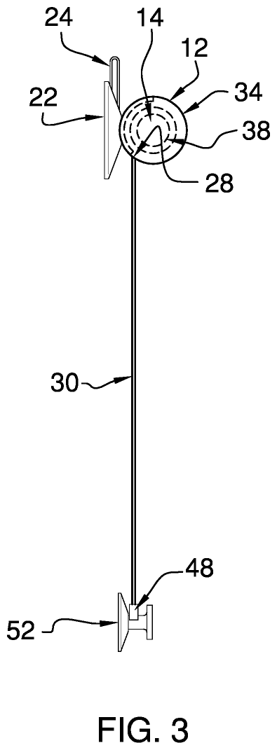

A bar 48 is engaged to a second end 50 of the panel 30 and is configured to be grasped in a hand of a user. The user is positioned to pull on the bar 48 to extend the panel 30 from the housing 12. A connector 52 is engaged to the bar 48 and is configured to selectively engage the window 16 upon extension of the panel 30 from the housing 12. The connector 52 thus is configured to retain the panel 30 substantially parallel to the window 16. As shown in FIG. 3, the connector 52 may comprise a suction cup 54.

In use, the housing 12 is engaged to a window 16 of a vehicle 18 one or both of the pair of cups 22 and the pair of hooks 24. The panel 30 then is extended from the slot so that the indicia 46 are viewable through the window 16. When the vehicle 18 is to be driven, the panel 30 can be retracted into the housing 12 by pushing the button 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A roll display sign device comprising:
a housing defining an interior space, the housing being configured for selectively engaging a window of a vehicle, such that the housing is removably engaged to the window;
a slot positioned in the housing;
a panel, the panel having a first end and a second end, the panel being wound, positioned in the interior space, and reversibly extensible through the slot, such that the panel is viewable through the window of the vehicle, the panel:
having indicia positioned thereon,
being configured for selectively engaging indicia, or
being configured for selectively engaging a sheet upon which indicia are positioned, such that the indicia are capable of being read by a person positioned proximate to the window; and
a bar engaged to the second end of the panel, wherein the bar is configured for grasping in a hand of a user, positioning the user for pulling on the bar for extending the panel from the housing, the bar having a length greater than a width of the panel wherein opposite ends of the bar are outwardly offset from respective lateral edges of the panel.

2. The roll display sign device of claim 1, wherein the housing is elongated cylindrically shaped.

3. The roll display sign device of claim 1, further including a plurality of fasteners engaged to the housing and being configured for selectively engaging the window of the vehicle, such that the housing is removably engaged to the window.

4. The roll display sign device of claim 3, wherein the plurality of fasteners comprises one or both of:
a pair of cups, the cups being resiliently compressible, wherein the cups are configured for compressing between the housing and the window for suctionally engaging the housing to the window; and
a pair of hooks, wherein the hooks are configured for insertion of an upper edge of the window for engaging the housing to the window.

5. The roll display sign device of claim 2, further including an extension module engaged to the housing and operationally engaged to the panel, such that the extension module enables selective positioning of the panel in a retracted configuration, wherein the panel is positioned within the housing, and an extended configuration, wherein the panel extends from the housing.

6. The roll display sign device of claim 5, wherein the extension module comprises:
a tube rotationally engaged to the housing and positioned in the interior space, the first end of the panel being engaged to the tube;
a spring engaged to the housing and operationally engaged to the tube, such that the spring is tensioned as the panel is extended from the housing;
a ratchet engaged to the tube;
a pawl hingedly engaged to the housing and gearedly engaged to the ratchet; and
a button engaged to the housing and operationally engaged to the pawl, wherein the button is configured for depressing for disengaging the pawl from the ratchet for retracting the panel into the housing.

7. (canceled)

8. The roll display sign device of claim 6, further including a connector engaged to the bar and being configured for selectively engaging the window upon extension of the panel from the housing, wherein the connector is configured for retaining the panel substantially parallel to the window.

9. The roll display sign device of claim 8, wherein the connector comprises a suction cup.

10. (canceled)

11. A roll display sign device comprising:
a housing defining an interior space, the housing being configured for selectively engaging a window of a vehicle, such that the housing is removably engaged to the window, the housing being elongated cylindrically shaped;
a plurality of fasteners engaged to the housing and being configured for selectively engaging the window of the vehicle, such that the housing is removably engaged to the window, the plurality of fasteners comprising one or both of:
a pair of cups, the cups being resiliently compressible, wherein the cups are configured for compressing between the housing and the window for suctionally engaging the housing to the window, and
a pair of hooks, wherein the hooks are configured for insertion of an upper edge of the window for engaging the housing to the window;
a slot positioned in the housing;
a panel, the panel being wound, positioned in the interior space, and reversibly extensible through the slot, such that the panel is viewable through the window of the vehicle, the panel:
having indicia positioned thereon,
being configured for selectively engaging indicia, or
being configured for selectively engaging a sheet upon which indicia are positioned, such that the indicia are capable of being read by a person positioned proximate to the window;
an extension module engaged to the housing and operationally engaged to the panel, such that the extension module enables selective positioning of the panel in a retracted configuration, wherein the panel is positioned within the housing, and an extended configuration, wherein the panel extends from the housing, the extension module comprising:
a tube rotationally engaged to the housing and positioned in the interior space, a first end of the panel being engaged to the tube,
a spring engaged to the housing and operationally engaged to the tube, such that the spring is tensioned as the panel is extended from the housing,
a ratchet engaged to the tube,
a pawl hingedly engaged to the housing and gearedly engaged to the ratchet, and
a button engaged to the housing and operationally engaged to the pawl, wherein the button is configured for depressing for disengaging the pawl from the ratchet for retracting the panel into the housing;
a bar engaged to a second end of the panel, the bar having a length greater than a width of the panel wherein opposite ends of the bar are outwardly offset from respective lateral edges of the panel, wherein the bar is configured for grasping in a hand of a user, positioning the user for pulling on the bar for extending the panel from the housing; and
a connector engaged to the bar and being configured for selectively engaging the window upon extension of the panel from the housing, wherein the connector is configured for retaining the panel substantially parallel to the window, the connector comprising a suction cup.
